(19) United States
(12) Patent Application Publication
(10) Pub. No.: US 2013/0099160 A1
(43) Pub. Date: Apr. 25, 2013

(54) Materials from Post-Industrial Absorbent Product Waste

(71) Applicants: Vasily A. Topolkaraev, Appleton, WI (US); Ryan J. McEneany, Appleton, WI (US); Neil T. Scholl, Neenah, WI (US); Thomas A. Eby, Greenville, WI (US)

(72) Inventors: Vasily A. Topolkaraev, Appleton, WI (US); Ryan J. McEneany, Appleton, WI (US); Neil T. Scholl, Neenah, WI (US); Thomas A. Eby, Greenville, WI (US)

(21) Appl. No.: 13/277,077

(22) Filed: Oct. 19, 2011

(51) Int. Cl. B01J 20/30; B01J 20/26

(52) U.S. Cl. 252/194

(57) ABSTRACT

The present invention relates to plastic composites that have been manufactured from post-industrial absorbent waste material. The waste material is transformed into densified particles that comprises from about 0% to about 65% of an absorbent core material, about 20% to about 45% of thermoplastic polymer, about 0% to about 10% inorganic filler particles, about 0% to about 10% elastics, and about 0% to about 10% adhesives. Also provided is a method for manufacturing a plastic composite by extruding or injection molding densified particles that have been formed from the post-industrial absorbent waste material.

### FIELD OF THE INVENTION

This invention relates to densified particles and methods for fabricating injection molded and extruded plastic parts along with durable plastic-fiber composites that employ recycled and/or conditioned post industrial waste from manufacturing facilities.

### BACKGROUND OF THE INVENTION

The production of absorbent products produces hundreds of millions of pounds of waste annually. The waste is comprised mostly of clean plastic with a majority being polypropylene, cellulosic fiber and superabsorbent polymer (SAP). In the past years, applications related to injection molded and extrusion plastic parts were developed with these post-consumer and post-industrial recycled plastics. These parts include durable goods such as automotive battery casings, paint cans, interior auto-parts, canisters, and the like. Additionally, new composite materials have entered the plastic product market. Referred as natural fiber and/or wood fiber plastic composites and glass and synthetic fiber plastic composites, the new materials have been accepted into different industries including a) automotive industry as internal panels and parts and external elements, b) building industry products in applications such as molding and trim, windows and doors, roofing, outdoor decking and railing, siding, fencing, and variety of other products. Recycled plastic streams are increasingly being used as a replacement for virgin resin in these composite applications. Currently, this large volume of clean and consistent plastic mix is underutilized and mainly discarded into landfills, recycled or burned. Portions of such waste are being sold to recycling manufacturers at a fraction of the cost for the virgin resin that is utilized in the manufacturing of absorbent articles.

With the desire to increase environmental sustainability, the present invention addresses the utilization of large volumes of manufacturing waste to enhance conservation efforts, decrease energy and combat the rising costs of supplies.

### SUMMARY OF THE INVENTION

The present invention relates to densified particles comprising post-industrial waste material wherein said post-industrial waste material comprises from about 0% to about 65% of an absorbent core material, about 20% to about 45% of thermoplastic polymer, about 0% to about 10% inorganic filler particles, about 0% to about 10% elastics, and about 0% to about 10% adhesives.

Also provided is a method for providing a plastic composite material that has been extruded or injection molded from the densified particles comprising post-industrial waste material wherein said post-industrial waste material comprises from about 0% to about 65% of an absorbent core material, about 20% to about 45% of thermoplastic polymer, about 0% to about 10% inorganic filler particles, about 0% to about 10% elastics, and about 0% to about 10% adhesives.

### DETAILED DESCRIPTION OF THE INVENTION

While the specification concludes with the claims particularly pointing out and distinctly claiming the invention, it is believed that the present invention will be better understood from the following description.

All percentages, parts and ratios are based upon the total weight of the compositions of the present invention, unless otherwise specified. All such weights as they pertain to listed ingredients are based on the active level and, therefore, do not include solvents or by-products that may be included in commercially available materials, unless otherwise specified. The term “weight percent” may be denoted as “wt. %” herein. Except where specific examples of actual measured values are presented, numerical values referred to herein should be considered to be qualified by the word “about”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

The term “absorbent article” or “absorbent product” generally refers to any article capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, and so forth; medical absorbent articles, such as garments, fenestration materials, underpads, bedpads, bandages, absorbent drapes, and medical wipes; food service wipers; clothing articles; and so forth.

As used herein, recycled, post-industrial absorbent product waste may be referred to as “PIAPW” and refers to the clean waste that collects when manufacturing absorbent articles that are used to produce the particles of the present invention.

“Modified PIAPW” as used herein, may include “article tailings” wherein most, if not all, of the absorbent core is removed from the PIAPW.

“Waste material” may be used herein generally to refer to the PIAPW or modified PIAPW of the present invention.

As used herein, “PIAPW-derived densified particles” refers to the PIAPW or modified PIAPW that has been size reduced to create aggregates, granulates or pellets which, ultimately may be used for the manufacturing of plastic articles such as those used in extrusion and injection molding.

In order to utilize the process of the present invention, it is necessary that the appropriate densified particles of the present invention be formulated from the PIAPW or modified PIAPW. The present invention realizes the appropriate range of elements necessary to achieve the high quality densified particles that may be utilized for extrusion and injection molding. Additionally, the invention can be applicable to the utilization of post-consumer absorbent product waste stream if the waste stream is properly cleaned, decontaminated, and dried.

Various absorbent articles at different stages of their manufacture may be used as the PIAPW according to the present invention. Typically, absorbent articles include a substantially liquid-impermeable layer (e.g., outer cover), a liquid-permeable layer (e.g., bodyside liner, surge layer, etc.), and an absorbent core. For purposes of discussion only, the absorbent article exemplified within the next section of the present description will be that of a diaper. However, as noted herein, other types of absorbent articles, such as incontinence articles, sanitary napkins, diaper pants, feminine napkins, children's training pants, and the like may be recycled and utilized according to the processes described herein to form the densified particles and methods of the present invention.

Diapers as an Absorbent Article to be Used as PIAPW

Generally, the diaper can include a chassis formed by various components, including an outer cover, bodyside liner, absorbent core, and surge layer. The absorbent core can be formed from a composite hydrophilic material formed from various natural or synthetic fibers, wood pulp fibers, regenerated cellulose or cotton fibers, or a blend of pulp and other fibers, superabsorbent material, and the like.

The outer cover is typically formed from a material that is substantially impermeable to liquids, such as from a thin plastic film or other flexible liquid-impermeable material (e.g., polyolefin films, polyolefin films laminated to a nonwoven web, etc.) and may include bicomponent fibers, such as polyethylene/polypropylene bicomponent fibers. The bodyside liner may be formed from a wide variety of materials, such as porous foams, reticulated foams, apertured plastic films, natural fibers (e.g., wood or cotton fibers), synthetic fibers (e.g., polyester or polyolefin fibers), or a combination thereof. In some embodiments, woven and/or nonwoven fabrics are used for the liner (e.g., meltblown and/or spunbonded webs of polyolefin fibers, bonded-carded web of natural and/or synthetic fibers, etc.). The liner may further be composed of a substantially hydrophobic material that is optionally treated with a surfactant or otherwise processed to impart a desired level of wettability and hydrophilicity.

The diaper may also include a surge layer that helps to decelerate and diffuse surges or gushes of liquid that may be rapidly introduced into the absorbent core. The surge layer is typically constructed from highly liquid-permeable materials. Suitable materials may include porous woven materials, porous nonwoven materials, and apertured films. Some examples include, without limitation, flexible porous sheets of polyolefin fibers, such as polypropylene, polyethylene or polyester fibers; webs of spunbonded polypropylene, polyethylene or polyester fibers; webs of rayon fibers; bonded carded webs of synthetic or natural fibers or combinations thereof.

Besides the above-mentioned components, the diaper may also contain various other components as is known in the art. For example, the diaper may also contain a substantially hydrophilic tissue wrapsheet, a ventilation layer positioned between the absorbent core and the outer cover, a pair of ears extending from the side edges of the diaper into one of the waist regions, a pair of containment flaps configured to provide a barrier and to contain the lateral flow of body exudates, various elastic or stretchable materials (e.g., a pair of leg elastic members affixed to the side edges to further prevent leakage of body exudates and to support the absorbent core and a pair of waist elastic members affixed to longitudinally opposed waist edges of the diaper); one or more fasteners, etc.

The various regions and/or components of the diaper may be assembled together using any known attachment mechanism, such as adhesive, ultrasonic, thermal bonds, etc. Suitable adhesives may include, for instance, hot melt adhesives, pressure-sensitive adhesives, and so forth. In the illustrated embodiment, for example, the outer cover and bodyside liner are assembled to each other and to the absorbent core using an adhesive. Similarly, other diaper components, such as the leg elastic members, waist elastic members and fasteners, may also be assembled into the diaper using any attachment mechanism.

### PIAPW-Derived Densified Particles

The present invention features densified particles derived from PIAPW or modified PIAPW. Overall, the PIAPW-derived densified particles can generally correspond to the PIAPW utilized as the starting material. As such, the PIAPW will generally include a thermoplastic component, inorganic filler particles, absorbent core material, elastics and adhesives.

The thermoplastic component present within the PIAPW may comprise thermoplastic polyolefin material including, but not limited to, polypropylene, polyethylene such as linear low density polyethylene (LLDPE) or mixtures or copolymers thereof, as well as other thermoplastic materials present in the waste such as polyesters, elastics, adhesives. The thermoplastic component may be present in the PIAPW from about 20% to about 45%, by weight of the absorbent article.

Inorganic filler particles present may be found within the PIAPW in an amount of from about 0% to about 10%, by weight of the absorbent article. Inorganic filler particles include, but are not limited to, CaCO₃ filler particles, clays or mixtures thereof.

The absorbent core material within the PIAPW may be present in an amount of from about 25% to about 65%, by weight of the absorbent article. The absorbent core may comprise from about 0% to about 100% of a cellulosic pulp material, about 0% to about 100% of a superabsorbent material (e.g., superabsorbent acrylic acid based materials), or a combination thereof.

Elastics and adhesives may also be present within the PIAPW depending on the type of absorbent article that makes up the PIAPW. Elastics and adhesives may each constitute from about 0% to about 10%, by weight of the absorbent article, of the PIAPW. Other materials that may also be present include, but are not limited to, pigments such as titanium oxide, surfactants, adhesives, and thermoset polymers such as thermoset polyurethane polymers.

Alternatively, the PIAPW can be modified to arrive at alternative embodiments of the PIAPW-derived densified particles. For example, the PIAPW can be stripped into article tailings having most, if not all of the absorbent core removed. As used herein, the term “article tailings” refers to an absorbent article having from about 0% to about 25%, from about 0% to about 15%, from about 0.5% to about 4%, from about 3% to about 10%, or about 0% to about 2%, by weight of the article, of the absorbent core material present within the waste material. This stripping can be especially useful to remove a majority of the absorbent core or at least reduce the presence of the absorbent core.

However, in other embodiments, additional materials may be added during or after the size reduction process with the PIAPW or modified PIAPW to achieve desired properties including, but not limited to, plasticizers, nucleating agents, acids, peroxides, surface modifiers, compatibilizers, processing aides, and/or polymers such as flow modifiers, block co-polymers, cross-linked rubbers, polyethylene, polypropylene, polyethylene terephthalate (PET), natural and synthetic fibers and combinations thereof. These additives can be added as a solid or liquid to the extruder along with the waste material and can be present in an amount of from about 0.1% to about 10%, from about 3% to about 5% or from about 0.1% to about 3%, by weight of the waste material.

Additionally, the PIAPW or modified PIAPW can be mixed with other post-consumer recycle (PCR) waste, virgin or reclaimed polymer materials, rubber waste, and/or other materials that could facilitate the size reduction process and/or add desired properties to the resulting particles.

Thus, the PIAPW-derived densified particles of the present invention can be comprised from blends with other polymers or PCR, from modified PIAPW that accounts for article tailings, from the initial PIAPW which, considers the presence of particular components, or a combination thereof. All in all, the present invention provides the advantages of and accounts for the various components of post-industrial waste, particularly of absorbent products, and provides a unique range of components that are downsized to form the PIAPW-derived densified particles that may be used for extrusion or injection molding as part of the manufacturing of plastic articles.

### Downsizing Processes

Generally speaking, the PIAPW or modified PIAPW can be downsized to produce the PIAPW-derived densified particles of the present invention. Depending on the composition of the PIAPW-derived densified particles desired, the individual components of the absorbent articles may not need to be separated prior to processing. Additionally, the composite mixture of the article waste can be generally preserved.

In one embodiment, the downsizing processes can generally use mechanical forces of shear, compression, and impact to tear and split apart solid materials into smaller pieces without substantially changing the waste's solid-state. Such downsizing machines can operate by various mechanisms, including, but not limited to, compression, impact, cutting, shearing, or a combination of these mechanisms. Compression generally involves applying mechanical energy to compress particles against a surface and fracture them into smaller particles. Impact mechanisms generally involve high-energy impacts at high speed to fracture the material. Cutting generally involves knives or other cutting tools to slice the material into smaller pieces. Shearing generally involves grinding the material by applying two forces acting in opposite directions along two parallel lines. The mechanism or combination of mechanisms can be selected depending on the waste characteristics and the desired geometries of the resulting particles.

Downsizing can also be accomplished using a combination of thermal and mechanical factors. For example, size reduction can be carried out cryogenically at temperatures well below ambient. The processes utilized in preparation of the PIAPW-derived densified particles from PIAPW or modified PIAPW waste can be categorized into several categories: coarse size reduction, densification, and fine size reduction. Any combination of these processes can be used to achieve the desired PIAPW-derived densified particles.

It is believed that the composite nature of the absorbent article waste, particularly the inclusion of several different incompatible compositions, can contribute to the ability of the waste to be downsized to a sufficient degree. Without wishing to be bound by any particular theory, it is also believed that the presence of inorganic filler material within the absorbent article waste (e.g., CaCO₃) can aid in the downsizing of the thermoplastic component and cellulosic components.

1. Course Size Reduction

The PIAPW or modified PIAPW can be first downsized into course waste shreddings that have a size sufficient to facilitate the further processing (e.g., to facilitate adding the waste to a hopper for further size reduction). While the course waste shreddings can have any suitable size for further processing, the course waste shreddings can in many embodiments have a size of about 0.25 cm to about 10 cm in the maximum width dimension and about 0.1 cm to about 2 cm in the maximum thickness dimension. Alternatively, the course waste shreddings can have a size of about 0.5 cm to about 5 cm in maximum width dimension and about 0.2 cm to about 1 cm in the maximum thickness direction. These course waste shreddings may be easier to further process utilizing subsequent downsizing techniques (or other processing steps).

For example, a conventional scrap chopping machine of the grinder type can be used to form the course waste shreddings, although other machines can be used to this end. One particularly suitable scrap chopping machine is available from Vecoplan, LLC (High Point, N.C.) as a film and fiber “FF” series single-shaft rotary grinders, and those described in U.S. Pat. No. 6,837,453 of Sturm and U.S. Pat. No. 7,168,640 of Lipowski. Another exemplary course size reduction machine is available from Cumberland Engineering Corporation (New Berlin, Wis.) as model no. X-1000. Other granulators are described in U.S. Pat. No. 4,932,595 of Cohen, et al. and U.S. Pat. No. 4,000,860 of Gotham, both of which are incorporated by reference herein. Of course, a combination or series of these processes can be utilized to form the course waste shreddings of the desired size.

A screen or other filtering sheet can be used to ensure that the course waste shreddings have been downsized to the desired size. For example, the waste material can be reduced to course waste shreddings having a size of less than 1 inch (i.e., about 2.54 cm), such as about 2 cm to about 2.5 cm, utilizing a screen size of 1 inch to ensure relatively small shredding size of the chopped waste material for further processing. In one embodiment, the waste material can be reduced to a size of less than 0.25 inch (i.e., about 0.6 cm), such as about 0.4 cm to about 0.6 cm) utilizing a screen size of 0.25 inch.

In one particular embodiment, the PIAPW or modified PIAPW can be transformed into the course waste shreddings while maintaining the solid-state of the thermoplastic material. For instance, the course downsizing processes can be performed at temperatures below the melting point of the thermoplastic component of the PIAPW or modified PIAPW.

2. Densification

Optionally, the PIAPW or modified PIAPW (e.g., in the form of course waste shreddings) can be densified prior to subjecting the waste to any additional processing. The densification processes can transform the course waste shreddings into densified particles or extended filaments that can be used as the PIAPW-derived densified particles or can provide the waste material in a manner that is readily transported and subjected to a fine size reduction process(es). For example, the waste material can be compressed under pressure into densified particles having an average diameter of about 2 mm to about 5 mm (e.g., about 3 mm).

According to these densification processes, the fibrous nature of the absorbent article waste, particularly the nonwoven webs of thermoplastic fibers, can be substantially maintained—at least on the microscopic level—through the densification process(es). For example, the densification processes may be performed at temperatures approaching the melting point of the thermoplastic component of the waste material, but not exceeding it for a time sufficient to fully melt it. Thus, the thermoplastic component of the waste material may soften and/or partially melt during the densification process to become tacky and allow for the material to agglomerate into a material with increased density. For example, the waste material can be heated during densification processes up to about 99% of the melt temperature of the thermoplastic component of the PIAPW, such as about 75% to about 95% of the melt temperature of the thermoplastic component.

Any suitable densification process or combination of processes can be utilized such as heat shredding densification, pellet milling, hot granulation, extrusion densification, and the like. For example, in one embodiment, the waste may be first subjected to hot granulation followed by extrusion densification.

a. Heat Shredding Densification

In one embodiment, the PIAPW or modified PIAPW can be shredded into densified particles. Generally, the course waste shreddings can be fed into a large drum having a spinning blade positioned at the bottom. As the material contacts the blade, it is shredded and heated by the fictional forces acting thereon. As the material continues to be shredded, it heats to a temperature sufficient to soften and/or partially melt the thermoplastic component of the waste material, causing the material to agglomerate. In one particular embodiment, the temperature of the waste material can be monitored and controlled during the heat shredding densification to ensure that the thermoplastic component does not completely melt. One particularly suitable hot shredding apparatus is available from Becher Engineering, Inc. (Menasha, Wis.).

According to this process, PIAPW or modified PIAPW material can be shredded into particles ranging from about 0.1 millimeter (mm) to about 25 mm, and in one embodiment about 1 mm to about 20 mm. According to the process, a wide range of particle sizes can be produced, since there is no particle size control mechanism.

b. Pellet Milling

The pellet milling process utilizes pressure to force the PIAPW or modified PIAPW material through a die of a predetermined size. As the material passes through the die, it is compacted and/or heated by the pressure forces acting thereon. Through the process, the material's temperature may rise up to or near the melting point of the thermoplastic component to cause the material to soften, through the increase in pressure during the process. In one embodiment, the increase in pressure raises the temperature of the waste material sufficient to soften and/or partially melt the waste material, causing the material to agglomerate for passage through the die. In another embodiment, the temperature of the material may stay relatively low through the pellet milling process, such as about 50% (i.e., about half) or less of the melting temperature of the thermoplastic component in the waste material.

As the waste material passes through the die, a filament is formed having a diameter that corresponds to the diameter of the die. For example, the die can have a diameter of up to about 10 mm, such as about 1 mm to about 5 mm. One particularly suitable pellet milling apparatus is available from Amandus Kahl (Reinbek, Germany).

The pellet milling process can generally provide filament segments having a substantially uniform diameter and shape corresponding to the size and shape of the die. However, the length of the strands may vary as desired. In one particular embodiment, the strands exiting the die generally fracture into smaller filament segments, such as having a length of about 5 mm to about 30 mm (e.g., about 7 to about 15 mm), upon exiting the die.

c. Hot Granulation

The hot granulation process utilizes pressure to force the PIAPW or modified PIAPW material through a die of a predetermined size, where a rotating blade cuts the material as it exits the die to form discrete granules. Through the process, the thermoplastic component's temperature rises near its melting point, causing the waste material to soften with the increase in pressure. As the waste material passes through the die, it is cut into the particle size as desired. Specifically, the increase in pressure raises the temperature of the waste material sufficient to soften and/or partially melt the waste material, causing the waste material to conglomerate for passage through the die.

The PIAPW or modified PIAPW material in the form of course waste shreddings is generally fed into the hot granulator and is cut between stationary and rotating knives as it exits the die. The end product size of the densified particles can be determined by the size of the holes in the screen. The hot melt granulation process can generally provide granules having a relatively small size distribution.

For example, the PIAPW or modified PIAPW material can be fed into a feed hopper into an agglomerating chamber, where frictional forces sinter/plasticize the material and press it through the holes of a special die. Agglomeration can occur in a fraction of a second, and right below the melting point of the material. Material exiting the die is cut by rotating knives and then conveyed (e.g., pneumatically) to into the hot-melt granulator, where it can be further cut between stationary and rotating knives. The end product size of the agglomerates can be determined by the size of the holes in the screen through which the waste material exits. The agglomerated densified particles can then be collected.

One particularly suitable hot melt granulator apparatus is available from Pallmann Industries (Clifton, N.J.), such as the Plast-Agglomerator, type PFV, and as disclosed in U.S. Pat. No. 6,469,6738, U.S. Pat. No. 7,467,585 of Pallmann and U.S. Pat. No. 7,311,511 of Pallmann.

d. Extrusion Densification

The PIAPW or modified PIAPW material can be densified in an extruder to form extruded filaments and/or pellets, according to processes known in the art of thermoplastic materials. For example, a single screw extruder can be utilized to form extruded pellets of the waste material. Alternatively, a twin screw extruder can be utilized to form extruded pellets of the waste material. Extrusion densification may be performed at temperatures above the melting temperature of the thermoplastic component in the waste material to ensure that the thermoplastic component of the waste melts to flow through the extruder. For example, the extrusion temperature can be about 190° C. to about 350° C., such as about 200° C. to about 300° C. This process can provide a high-throughput process that is readily available to those in the art, but may alter and reduce the fibrous structure of the thermoplastic component of the PIAPW or modified PIAPW. As such, the resulting densified particles may have a different morphology than those processes that avoid melting of the thermoplastic component of the PIAPW or modified PIAPW.

3. Fine Size Reduction

The PIAPW or modified PIAPW material can be downsized into particles utilizing a fine size reduction process(es) to form the PIAPW-derived densified particles of the present invention. These fine size reduction processes can transform the PIAPW or modified PIAPW, either before or after shredding via a course size reduction process(es) and/or densification process(es), into the PIAPW-derived densified particles. Generally, the fine size reduction process can provide particles having fibrous and/or flake-like structures with a relatively high aspect ratio and/or relatively narrow particle size distribution. Additionally, the fine size reduction process can form these particles with highly texturized surfaces and with relatively high void space and/or porosity. Though any suitable fine size reduction process can be utilized, several specific processes are described in greater detail below. In one embodiment, the fine size reduction process can be performed at temperatures below the melting temperature of the thermoplastic material within the waste material, in order to somewhat preserve the solid-state characteristics of the waste material as supplied to the fine size reduction process. For example, the waste material can be heated during the fine size reduction processes up to about 75% of the melt temperature of the thermoplastic component of the waste material, such as about 25% to about 60% of the melt temperature of the thermoplastic component.

In addition, the densified particles produced from the fine size reduction process(es) can be subjected to further processing, as desired. Such further treatments can further reduce particle size, change the particle shape, modify the particle surface, change the color of the particles, blended with polymeric materials, etc.

a. Impact Downsizing

The PIAPW or modified PIAPW can be subjected to impact and shear forces to reduce the waste to particles having the desired size. According to one embodiment of impact downsizing, the waste material is downsized utilizing a grinder utilizing a rotating grinding element. For example, repeated impact and/or shear stress can be created between a rotating grinding element and a stationary or counter-rotating grinding element. Additional impact and shear forces can be applied to the waste material through impact of the PIAPW-derived densified particles with each other within the system.

One particularly suitable impact downsizing apparatus is available commercially from Pallmann Industries (Clifton, N.J.) under the name Turbofiner®, type PLM. Other suitable impact downsizing apparatus are described in U.S. Pat. No. 6,431,477 of Pallmann and U.S. Pat. No. 7,510,133 of Pallmann.

b. Cold Extrusion Downsizing

Cold extrusion downsizing can utilize shear and compression forces to downsize the PIAPW or modified PIAPW into particles. Cold extrusion downsizing processes can utilize typical extrusion equipment, known to those skilled in the processing of plastics. In particular, the waste material can be forced through a die at temperatures below the melting point of the thermoplastic component of the PIAPW or modified PIAPW. However, during the cold extrusion process, the waste material may increase in temperature due to the compression and shear forces acting thereon.

For example, the cold extrusion downsizing process can be carried out at a temperature of less than about 100° C., such as about 35° C. to about 75° C., and particularly about 40° C. to about 50° C. At these temperatures, the thermoplastic component of the waste material does not melt, substantially preserving its fibrous nature.

Although a single screw extruder may be utilized, in one particular embodiment, a twin screw extruder is utilized to form the particles of the PIAPW-derived densified particles. Twin screw extruders can have co-rotating or counter-rotating, intermeshing or nonintermeshing screws that can create a high shear, high intensity mixing action for increased downsizing of the PIAPW or modified PIAPW. In addition, the configurations of the screws themselves may be varied using forward conveying elements, reverse conveying elements, kneading blocks, and other designs in order to achieve particular mixing characteristics. Thus, the flexibility of twin screw extrusion equipment allows for specific tailoring of the process according to the desired product configuration.

Exemplary twin screw extruders include, but are not limited to, those available commercially under the names Brabender® D-6 (C.W. Brabender® Industries, Inc. of South Hackensack, N.J.), Prism USALAB 16 Twin Screw Extruder (Thermo Electron Corp., Stone, England) and the ZSK series of twin screw extruders (Coperion Corp., Ramsey, N.J.; formally Werner and Pfleiderer Corporation).

c. Solid-State Shear Pulverization Downsizing

A solid-state shear pulverization (SSSP) recycling process can be used to convert PIAPW and/or modified PIAPW into the PIAPW-derived densified particles of the present invention. In general, the SSSP recycling process increases the specific surface area of waste material into the flake powder having a smaller size. SSSP recycling processes, due to the shearing and tearing mechanisms, can provide densified particles that have a plate-like, anisotropic structure and relatively narrow particle size distribution. Additionally, the fibrous structure of the source material (e.g., the absorbent article tailings) can be at least partially preserved as material is not undergoing melting during the SSSP recycling process. For example, the SSSP recycling process uses shearing and tearing forces that preserve the fibrous structure of the waste material while allowing for more elongated and plate-like downsized particulate material.

The PIAPW or modified PIAPW is generally subjected to a SSSP recycling process that pulverizes the waste particles without melting the materials. As such, certain structural features of the waste can be preserved in the SSSP process. The solid-state shear pulverization recycling process generally utilizes a continuous extrusion process carried out under high shear and compression conditions while the extruder barrels and a screw are cooled to prevent polymer melting.

For example, extruders and/or screws, along with their related SSSP processes, are disclosed in U.S. Pat. No. 5,814,673 of Khait; U.S. Pat. No. 6,479,003 of Furgiuele, et al.; U.S. Pat. No. 6,494,390 of Khait, et al.; U.S. Pat. No. 6,818,173 of Khait; and U.S. Publ. No. 2006/0178465 of Torkelson, et al.

d. Cryogenic Disk Milling Process

The cryogenic disk milling process generally uses liquid nitrogen to cool (e.g., freeze) the thermoplastic material of the waste material prior to and/or during a variety of grinding mechanisms. The systems can be configured in multiple ways in order to tailor the final powder distribution depending on the application. In one embodiment, a single-runner disk milling apparatus can be utilized. The single-runner disk milling apparatus has a stationary disk and a rotating disk. Material enters between the discs via a channel near the disk center. The waste material is size reduced through the frictional forces created between the discs as the discs rub against each other. The top size of the densified particles can be determined by material having to pass through a screen with a specified mesh size in order to exit a discharge port. Suitable mesh sizes can be about 5 to about 75, such as about 25 to about 60. For example, one suitable cryogenic disk milling apparatus is available under the name Wedco® cryogenic grinding system from ICO Polymers (Allentown, Pa.).

The cryogenic disk milling process can produce more rounded, less fibrous structures due to the brittle fracturing that occurs at the freezing temperatures of the process, instead of shearing forces. Thus, the resulting densified particles may have less fibrous structures that have a higher bulk density than achieved through other fine size reduction processes, which could compromise the properties of the product.

### Separation Methods

The PIAPW may be put through separation processes to form modified PIAPW which, comprises a minimized SAP and cellulose content that makes it more effective for creating an alternative embodiment of the PIAPW-derived densified particles of the present invention. Separation methods may include but are not limited to: cyclonic separation, centrifugal air classification, gravity air classifiers, high-energy dispersion classifiers, spiral separator classifiers, turbine classifiers, elutriators, centrifugal screeners, elutriation-vortex separators, gyratory screeners, inline pneumatic, sifters, perforated plate screeners, reciprocating screeners, rotary screeners, scalpers, shakers, sieves, sifters, tumbler screeners, ultrasonic screeners, vibratory screeners, wedgeshot screeners, and the like.

### Cyclonic Separation

The PIAPW may be modified in order to provide modified PIAPW which comprises a minimized SAP and cellulosic content by means of known technologies such as, for example, cyclonic separation. Cyclonic separation removes particulates from an air stream and can be configured to maximize the elimination of SAP and cellulose particles. It may also be targeted for a removal of particular ranges of particle size and/or used in a series configuration. Because one embodiment of the present invention has substantially no SAP present within the composition, it is desirable to utilize technology that is capable of removing SAP from the PIAPW in order to provide such modified PIAPW. A significant reduction in SAP content can be achieved as a result of cyclonic separation. In turn, such removal can help improve tensile strength, impact strength, toughness, elongation at break, and the like. It also reduces/minimizes defects in the finished composition. In general, the ability to separate materials by cyclonic separation is defined by a balancing of forces enacted on the PIAPW while traveling through a fluid (in this case air). After cyclonic separation, the modified PIAPW can be granulated and/or granulated into small granules for use during a melt filtration stage to further clean the stream and form an alternative embodiment of PIAPW-derived densified particles of the present invention.

Once the PIAPW-derived densified particles have been formed from PIAPW or modified PIAPW, an alternative embodiment may include feeding such particles into a single or twin extruder to further blend with other virgin and/or recycled polymers including, but not limited to, polypropylene, polyvinyl chloride, polyethylene, acrylonitrile butadiene plastics, and the like. The amount of blended virgin or recycled polymers in the blend can vary depending on targeted properties of the material and typically can be in the range from about 20% by weight of the blended densified particles to about 95% by weight of the blended densified particles. Compatibilizers include, but are not limited to, polar-group grafted polymers such as maleic anhydride grafted polymers and copolymers, epoxy-functional polymers and copolymers, oxazoline-functional polymers and copolymers, and the like that can be used to blend and compatibilize the polymers and densified particles together. Processing aids and flow modifiers can also be added to adjust the flow rate profiles and melt flow rate of the blend. Peroxide additives can be used to reduce the polypropylene molecular weight and initiate in-situ grafting reaction. Additives and compatibilizers may form a blend formulation with required compatibility parameters for use as different plastic components and processability.

If not blended with other polymers, the PIAPW-derived densified particles may be used directly to form extrusion and injection molded parts. Additionally, various natural, synthetic and glass fibers can be used to form a composite blend with the densified particles and the blends of PIAPW-derived densified particles with other virgin or recycled polymers. Various fibers can be blended with the densified particles using known in the art methods such as extrusion blending, high intensity shear mixing, tumble blending and the like. The amount of fibers in a composite blend can vary in the range of from about 10% by weight of the total blend composition to about 70% by weight of the total blend composition. Alternatively the amount of fiber can vary from about 20% by weight to about 60% by weight of the total blend composition. Natural fibers may include, but are not limited to, sisal fiber, kenaf fiber, bamboo fiber, cellulosic fiber, wood fiber, wood meal, and the like. Synthetic fibers may include, but are not limited to, polypropylene fiber, nylon fiber, polyethylene fiber, polyester fiber, polylactic acid fiber, and the like. Glass fibers may include, but are not limited to, E-glass fiber, S-glass fiber and the like. Compatibility and interaction between the fibers and the PIAPW-derived composition may be improved with the use of maleic anhydride-grafted polymeric additive, polar-group grafted polymeric additives, and the like. Additionally, coupling agents may be used to bond and interact the fibers and PIAPW-derived composition at the interface. Flow modifiers can be added to improve flow profile, fiber mixing, and melt flow rates of the PIAPW-derived densified particles. Inorganic or organic fillers can also be added to the formulation to improve stiffness, aesthetics, or other properties of the densified particles. Additionally, extruded or injection molded composite may comprise a foaming agent to reduce the density of the densified particles and composite.

### PIAPW-Derived Densified Particles Characterization

The shape of the granulated PIAPW-derived densified particles can range from spherical or elliptical, as achieved through extrusion and under water pelletization, or cylindrical, as achieved through extrusion and strand pelletization. Cylindrical granules can also be achieved by compression through a die such as in pellet milling processes. More irregular shaped granules can be also be achieved through the use of sizing equipment such as granulators where the granule is continually size reduced between a fixed and rotating blade until the granule is small enough to pass through a screen with fixed orifice sizes. The granules may alternatively be produced directly from the exit of an extrusion line with no pelletizing die. In this method, the resulting granules are flake-like or plate-like with an inconsistent ratio of length to width.

The PIAPW-derived densified particles are in a form such that the longest linear measurement of a densified particles is typically from about 1 mm to about 10 mm, or about 3 mm to about 7 mm, or about 4 mm to about 6 mm. Individual particles may have a density ranging from about 0.4 gram per cubic centimeter to about 1.2 gram per cubic centimeter. Additionally, individual particles, when packed in bulk will result in a packing density that is less than that of the individual particle. The packing density may range from about 0.02 grams per cubic centimeter to about 1.1 gram per cubic centimeter, or about 0.05 to about 0.5 grams per cubic centimeter, or about 0.1 to about 0.6 grams per cubic centimeter. A higher packing density may be desired for more efficient transportation, storage, and processing efficiencies.

The PIAPW-derived densified particles, when in granule from, has a uniform color appearance, which could be influenced by the colors of the components making up the PIAPW or modified PIAPW. Although most often, the PIAPW-derived densified particles appear as white, they also have the ability to be pigmented to other desirable colors during any densification steps or during any of the post processing to form the PIAPW-derived densified particles into a finished good. For example, in one embodiment, a primarily white absorbent product was reclaimed and transformed into granules. Once converted to granules, the previously white PIAPW turned green, more than likely as a result of pigments that appeared on the initial absorbent product. Such granules could be favored as environmentally-friendly and marketed as a valued “GREEN” product. Other colors could also drive value to indicate environmental and/or recyclable indicators of goods.

Manufacturing Plastic Composites with PIAPW-Derived Densified Particles

Profile Extrusion

The PIAPW-derived densified particles may be used directly or alternatively with blends of other materials such as polymers and various natural and synthetic fibers to form extrusion and injection molded parts. Extrusion is a process used to create objects of a fixed cross-section profile. The PIAPW-derived densified particles or blends, are pushed or drawn through a die of desired cross-section. Two main advantages of this process over other manufacturing processes are its ability to create a complex cross-section and its ability to work with materials that are brittle and have low elongations at break. This is especially important for multicomponent waste material from absorbent product such as the PIAPW-derived densified particles or blends of the present invention. During profile extrusion, the PIAPW-derived densified particles or blends will only encounter compressive and shear stresses which prevents failure of the brittle material system. It also forms finished parts with an excellent surface finish.

Extrusion may be continuous or discontinuous. Cross-section profiles can have flat sheet geometry or can have hollow cavities. For example, tubular and pipe-like structures can be extruded in a continuous process. Also, parts with several hollow cavities can be easily extruded. The extrusion process can be done with the material hot or cold. Hot extrusion might be more preferred for some applications due to easier flow of material and lower pressure applied during the extrusion process. During the extrusion process, the PIAPW-derived densified particles or blends are fed into the extruder hopper where they are conveyed continuously forward by a rotating screw inside a heated barrel while being softened by both friction and heat. The softened PIAPW-derived densified particles or blends are then forced out through a die of a desired cross-section directly into cool water and onto an air cooled belt so that they may solidify. is the solidified particles are then conveyed onwards into the take-off rollers, which actually do the pulling of the softened material from the die.

Extrusion Blow Molding

The PIAPW-derived densified particles including its blends with other materials can be fed into a Blow Molder where it is conveyed forward by a screw inside a heated barrel while being softened by heat and shear. The softened PIAPW-derived densified particles or blends are then forced downwards through a circular die forming a hollow tube called a “parison”. The parison is then clamped inside a hollow mold and inflated from with-in. The air pressure forces the parison to inflate against the mold surface and the PIAPW-derived densified particles or blends are then cooled into the shape of the interior of the mold cavity. The mold then opens and the product is ejected. Extrusion blow can be used to make bottles, jugs, and other containers. Other processes for blow molding of PIAPW-derived densified particles or blends can include stretch blow and injection blow molding.

Injection Molding

Injection molding is a process to manufacturing parts from polymeric materials including the PIAPW-derived densified particles or blends of the present invention. The material is fed into a heated barrel and forced into a molded cavity where the material cools and solidifies to the shape of the mold cavity. The solidified material is then ejected from the mold cavity.

Rotational Molding

Rotational molding is a process where thermoplastic materials, including the PIAPW-derived densified particles or blends of the present invention are formed into hollow parts. Rotational molding, also called spin casting, rotomolding or rotocasting, involves filling a molded with a polymer (polymer is typically in a powder form). The mold is then rotated and heated causing the material to soften, disperse, and form to the walls of the mold. The mold is cooled to solidify the polymer in the configuration of the mold followed by removal of the plastic part. Fine size reduced particles such as the PIAPW-derived densified particles or blends of the present invention can be used for rotational molding.

Compression Molding

Compression molding is a process to form parts from polymers. Compression molding involves placing polymers, including the PIAPW-derived densified particles or blends of the present invention directly into a heated metal mold, where the polymer is softened by the heat, as the mold closes the polymer is forced to conform to the configuration of the mold, when the mold opens the polymer retains the shape of the mold and is ejected from the mold.

Multi-Component Profile Extrusion and Extrusion/Injection Blow

Two or more different components can be used to form extrusion profile products or extrusion/injection blow parts. For two or multi-component co-extrusion products or parts, two or more extruders can be used to extrude different materials. For example, when using profile extrusion, PIAPW or modified PIAPW materials can be extruded as a core of a profile while other polymers can be extruded as a “skin” or external layer. This approach can provide profiles and products with improved properties, surface finish and weather/aging resistance as a weaker waste material can be extruded and used to be enclosed and protected by a stronger “skin” polymer material. The profile can have two or more layers of different PIAPW or modified PIAPW materials where the PIAPW or modified PIAPW based material may be positioned as an internal layer.

Similarly, two-component co-extrusion blow and co-injection blow molding can be conducted. Typically, two different PIAPW or modified PIAPW materials may be injected or transferred into a mold sequentially or simultaneously. The core material can be a waste based material which can comprise fibers, fillers, different polymers, and even voids or gas. The “skin” material may generally be a prime polymer with required surface and bulk properties for intended use. The sandwich core-skin structure with prime material in the skin and waste material in the core can have significantly improved mechanical, durability, surface, aging/weathering, and other properties as compared to material made from 100% waste material.

Examples of machines suitable for co-injection, sandwich or two-component molding include machines produced by Presma Corp., Northeast Mold & Plastics, Inc., and other manufactures.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

Melt Flow Rates

All Melt flow rates were measured at 230° C., 2.16 kg mass, 360 second hold time according to ASTM D1238-10.

Material for Example 2 (Agglomerated diaper tailing waste Pallmann V5) was measured to have a melt flow rate of 4 g/10 min.

Material for Example 1 (Filtered Agglomerated Diaper Tailing Waste Pallmann V6) was measured to have a melt flow rate of 11 g/10 min.

Material for Example 1 with Additional Filtering (2× filtered Agglomerated Diaper Tailing Waste Pallmann V6+30 mesh filter during extrusion) was measured to have a melt flow rate of 23.5 g/10 min.

Material for Example 1 with Additional Filtering (2× filtered Agglomerated Diaper Tailing Waste Pallmann V6+60 mesh filter during extrusion with 0.1% peroxide addition) were measured to have a melt flow rate of 79.8 g/10 min.

Virgin PP melt flow rate in diaper product is typically in the range of 25-35 g/10 min at 230° C.

### Example 1

The ability to form granules from PIAPW was demonstrated. The PIAPW was provided in baled form by the Barton Diaper Mill located in Barton Upon Humber, UK. These bales were manually opened by cutting baling wires and fed into cyclonic separation unit (PMS unit available from Pallmann Industries of Zweibrucken, Germany) to remove a majority of the residual SAM and cellulose content. The plastic portion of the waste stream was then pneumatically conveyed to a shredding unit (PS Knife Mill available from Pallmann Industries) where the material was size reduced between a stationary blade and rotating blade until the material was small enough to pass through a 10 mm screen. The shredded material was then pneumatically conveyed to a feed auger that metered the material into a densification unit (PFV agglomerator from Pallmann Industries) where the material was compressed through a die with orifice sizing of 2.8 mm. The compressed material was partially melted due to heat generated by friction and pressure and was scraped from the die face by a rotating knife. The material was then pneumatically conveyed to a hot melt granulator (part of the PFV-agglomerator) where the densified material was uniformly size reduced between a stationary blade and a rotating blade until the material could pass through a screen with 10 mm openings. This material was denoted as “V6” and was found to have a melt flow rate of 11 g/10 min (230° C./2160 g).

### Example 2

Same as Example 1 but the cyclonic separation unit was bypassed. This material was denoted as “V5” and was found to have a melt flow rate 4 g/10 min (230° C./2160 g).

### Example 3

V6 material was dry blended with Pro-fax SV954 Polypropylene Impact Co-polymer from LyondellBasell Industries at ratio of 20/80 by weight V6 to SV954 Polypropylene. The polymers were fed into a co-rotating, twin-screw extruder (ZSK-30, diameter of 30 mm, length of 1328 millimeters) that was employed for compounding and manufactured by Werner and Pfleiderer Corporation of Ramsey, N.J. The extruder possessed 14 zones, numbered consecutively 1-14 from the feed hopper to the die. The first barrel #1 received the resins via gravimetric feeder at a total throughput of 15 pounds per hour. The die used to extrude the resin had 3 die openings (6 millimeters in diameter) that were separated by 4 millimeters. Upon formation, the extruded resin was cooled on a fan-cooled conveyor belt and formed into pellets by a Conair pelletizer. The screw speed was 200 revolutions per minute (“rpm”). Samples were injection molded (BOY 22D injection molding machine, Spritzgiessautomaten) into a standard 4-cavity test mold to form ASTM D638D Type I Tensile Bar 0.125″×0.500″×6.5″, ASTM D638 Type V Tensile Bar 0.060″×0.125″×2.5″, and ASTM D790 Flex Bar 0.125″×0.5″×5.0″, and 2.5″ diameter round disk. Injection molding temperature set at 200° C. with a heating and injection time of 20 seconds followed by cooling of the mold for 20 seconds at 24° C.

### Example 4

Same as Example 3, except composition ratio was 40/60 by weight V6 to SV954 Polypropylene.

### Example 5

Same as Example 3, except 20/80 dry blend of V6 and SV954 was not melted blended on ZSK-30 twin-screw extruder and instead was directly injection molded.

### Example 6

Same as Example 3, except composition ratio was 40/60 by weight V6 to SV954 Polypropylene and dry blend of V6 and SV954 was not melt blended on ZSK-30 twin-screw extruder and instead was directly injection molded.

### Example 7

Sample as Example 3, except 3% by weight of maleic anhydrite-grafted polypropylene, Polybond 3150® from Chemtura was added to the dry blend before extrusion.

### Example 8

Same as Example 3, except dry blend composition was neat V6+3% by weight Polybond 3150®.

### Example 9

Same as Example 3 except the dry blend composition was 100% neat SV954 Polypropylene and no extrusion blending was done.

All tensile bars from Examples 4-9 were tested on an MTS 810 hydraulic tensile frame in accordance with ASTM-638D-10. Test results are presented in Table below.

| | | Standard | Average | Standard | Average | Standard |
|---|---|---|---|---|---|---|
| | Average | Deviation | Break | Deviation | Elongation | Deviation |
| | Modulus | Modulus | Stress | Break | at Break | Elongation |
| Example | (MPa) | (MPa) | (MPa) | Stress | (%) | at Break (%) |
| 4 | 1395 | 19 | 18 | 0.2 | 13.3 | 2.6 |
| 5 | 1468 | 33 | 21 | 0.4 | 7.7 | 2.5 |
| 6 | 1427 | 38 | 20 | 0.6 | 8.2 | 2.3 |
| 7 | 1409 | 40 | 19 | 0.4 | 10.7 | 0.6 |
| 8 | 1347 | 28 | 19 | 0.2 | 9.1 | 0.6 |
| 9 | 1528 | 47 | 16 | 0.9 | 38.0 | 9.6 |

### Example 10

V6 material was dry blended with Terluran GP-22 Acrylonitrile Butadiene Styrene (ABS) from BASF Corporation at ratio of 20/80 by weight V6 to GP-22 ABS. The polymers were fed into a co-rotating, twin-screw extruder (ZSK-30, diameter of 30 mm, length of 1328 millimeters) that was employed for compounding and manufactured by Werner and Pfleiderer Corporation of Ramsey, N.J. The extruder possessed 14 zones, numbered consecutively 1-14 from the feed hopper to the die. The first barrel #1 received the resins via gravimetric feeder at a total throughput of 15 pounds per hour. The die used to extrude the resin had 3 die openings (6 millimeters in diameter) that were separated by 4 millimeters. Upon formation, the extruded resin was cooled on a fan-cooled conveyor belt and formed into pellets by a Conair pelletizer. The screw speed was 200 revolutions per minute (“rpm”). Samples were injection molded (BOY 22D injection molding machine, Spritzgiessautomaten) into a standard 3-cavity test mold to form ASTM D638D Type I Tensile Bar 0.125″×0.500″×6.5″, ASTM D638 Type V Tensile Bar 0.060″×0.125″×2.5″, and ASTM D790 Flex Bar 0.125″×0.5″×5.0″, and 2.5.″ Injection molding temperature set at 230° C. with a heating and injection time of 35 seconds followed by cooling of the mold for 25 seconds at 74° C.

### Example 11

Same as example 10, except 3% by weight Polybond 3150® from Chemtura was added

### Example 12

Same as example 11 but with a less intensive mixing extruder screw configuration.

### Example 13

Same as Example 10 except the dry blend composition was 100% neat GP-22 ABS and no extrusion blending was done.

All tensile bars for materials from examples 10-13 were tested on an MTS 810 hydraulic tensile frame in accordance with ASTM-638D-10

| | | Standard | Average | Standard | Average | Standard |
|---|---|---|---|---|---|---|
| | Average | Deviation | Break | Deviation | Elongation | Deviation |
| | Modulus | Modulus | Stress | Break | at Break | Elongation |
| Example | (MPa) | (MPa) | (MPa) | Stress | (%) | at Break (%) |
| 10 | 1937 | 14 | 30.3 | 0.8 | 3.0 | 0.1 |
| 11 | 1912 | 14 | 30.4 | 0.1 | 3.1 | 0.2 |
| 12 | 1878 | 24 | 29.1 | 0.6 | 2.9 | 0.2 |
| 13 | 2087 | 21 | 30.2 | 0.6 | 15.3 | 5.8 |

### Example 14

The V6 material from Example 1 was blended with 0.1% of peroxide and additionally melt filtered during extrusion process using 60 mesh filter. The melt flow rate of the resulting material was 79.8 g/10 min at 230° C. and 2160 g load.

### Example 15

The V6 material from Example 1 was additionally melt filtered using 30 mesh filter during extrusion. The resulting filtered material demonstrated melt flow rate of 23.5 g/10 min at 230° C. and 2160 g load.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Densified particles comprising post-industrial waste material wherein said post-industrial waste material comprises from about 0% to about 65% of an absorbent core material, about 20% to about 45% of thermoplastic polymer, about 0% to about 10% inorganic filler particles, about 0% to about 10% elastics, and about 0% to about 10% adhesives.

2. The densified particles of claim 1 wherein the absorbent core material of the post-industrial waste material is present in an amount of from about 0.5% to about 25%, by weight of the post-industrial waste material.

3. The densified particles of claim 1 wherein the absorbent core material of the post-industrial waste material comprises about 0% to about 100% cellulose, about 0% to about 100% superabsorbent material, and combinations thereof.

4. The densified particles of claim 1 wherein the post-industrial waste material further comprising additives selected from the group consisting of pigments, surfactants, flow modifiers, additional polymers selected from virgin and reclaimed polymers, compatibilizers, and fibers selected from natural fibers, synthetic fibers, glass fibers and combinations thereof.

5. The post-industrial waste material of claim 4 wherein the virgin and reclaimed polymers are selected from polypropylene, polyvinyl chloride, polyethylene, acrylonitrile butadiene plastics, and combinations thereof.

6. The post-industrial waste material of claim 4 wherein the compatibilizers are selected from polar-group grafted polymers such as maleic anhydride grafted polymers, epoxy-functional polymers and copolymers, oxazoline-functional polymers and copolymers, and combinations thereof.

7. The post-industrial waste material of claim 4 wherein the natural fibers are selected from the group consisting of sisal fiber, kenaf fiber, bamboo fiber, cellulosic fiber, wood fiber, wood meal, and combinations thereof; the synthetic fibers are selected from the group consisting of polypropylene fiber, nylon fiber, polyethylene fiber, polyester fiber, polylactic acid fiber, and combinations thereof; and glass fibers are selected from E-glass fibers, S-glass fibers and combinations thereof.

8. The post-industrial waste material of 4 wherein the additives are present in an amount from about 0.1% to about 5%, by weight of the waste material.

9. The densified particles of claim 1 wherein the linear measurement of densified particles is from about 1 mm to about 10 mm.

10. The densified particles of claim 1 wherein the bulk density of densified particles is from about 0.02 grams per cubic centimeter to about 1.1 gram per cubic centimeter.

11. A method of producing the densified particles of claim 1 wherein said post-industrial waste material is downsized, said downsizing occurring by way of course size reduction, densification, fine size reduction, or combinations thereof.

12. The method of claim 11, wherein additives selected from the group consisting of pigments, surfactants, flow modifiers, additional polymers selected from virgin and reclaimed polymers, compatibilizers, fibers selected from natural fibers, synthetic fibers, and glass fibers and combinations thereof are added during the downsizing of the post-industrial waste material.

13. The method of claim 11, wherein additives selected from the group consisting of pigments, surfactants, flow modifiers, additional polymers selected from virgin and reclaimed polymers, compatibilizers, fibers selected from natural fibers, synthetic fibers, and glass fibers and combinations thereof are added after the downsizing of the post-industrial waste material.

14. A plastic composite comprising the densified particles of claim 1.

15. A method of manufacturing the plastic composite of claim 14, the method comprising the steps of providing densified particles, said densified particles comprising post-industrial waste material wherein said post-industrial waste material comprises from about 0% to about 65% of an absorbent core material, about 20% to about 45% of thermoplastic polymer, about 0% to about 10% inorganic filler particles, about 0% to about 10% elastics, and about 0% to about 10% adhesives; and extruding said densified particles into a plastic composite.

16. A method of manufacturing the plastic composite of claim 14, the method comprising the steps of providing densified particles, said densified particles comprising post-industrial waste material wherein said post-industrial waste material comprises from about 0% to about 65% of an absorbent core material, about 20% to about 45% of thermoplastic polymer, about 0% to about 10% inorganic filler particles, about 0% to about 10% elastics, and about 0% to about 10% adhesives; and injection molding said densified particles into a plastic composite.

17. A method of manufacturing a plastic composite, the method comprising the steps of blending the densified particles of claim 1 with from about 20% to about 95%, by weight of the blended densified particles, virgin and reclaimed polymers selected from the group consisting of polypropylene, polyvinyl chloride, polyethylene, acrylonitrile butadiene plastics, or combinations thereof; extruding said blended particles; cooling said blended particles; and injection molding said blended particles into a plastic composite.

18. A method of manufacturing a plastic composite, the method comprising the steps of blending the densified particles of claim 1 with from about 20% to about 95%, by weight of the blended densified particles, virgin and reclaimed polymers selected from the group consisting of polypropylene, polyvinyl chloride, polyethylene, acrylonitrile butadiene plastics, or combinations thereof; and extruding said blended particles into a plastic composite.

19. A method of manufacturing a plastic composite, the method comprising the steps of blending the densified particles of claim 1 with natural fibers selected from the group consisting of sisal fiber, kenaf fiber, bamboo fiber, cellulosic fiber, wood fiber, wood meal, synthetic fibers selected from the group consisting of polypropylene fiber, nylon fiber, polyethylene fiber, polyester fiber, polylactic acid fiber, glass fibers selected from E-glass fibers, S-glass fibers, and combinations thereof; extruding said blended particles; cooling said blended particles; and injection molding said blended particles into a plastic composite.

20. A method of manufacturing a plastic composite, the method comprising the steps of blending the densified particles of claim 1 with natural fibers selected from the group consisting of sisal fiber, kenaf fiber, bamboo fiber, cellulosic fiber, wood fiber, wood meal, synthetic fibers selected from the group consisting of polypropylene fiber, nylon fiber, polyethylene fiber, polyester fiber, polylactic acid fiber, glass fibers selected from E-glass fibers, S-glass fibers, and combinations thereof; extruding said blended particles; cooling said blended particles; and extruding said blended particles into a plastic composite.
